(19) United States
(12) Patent Application Publication
(10) Pub. No.: US 2017/0003907 A1
(43) Pub. Date: Jan. 5, 2017

(54) COMPILATION APPARATUS AND COMPILATION METHOD

(71) Applicant: FUJITSU LIMITED, Kawasaki-shi (JP)

(72) Inventor: Fumie Kunisada, Mishima (JP)

(73) Assignee: FUJITSU LIMITED, Kawasaki-shi (JP)

(21) Appl. No.: 15/180,588

(22) Filed: Jun. 13, 2016

(30) Foreign Application Priority Data
Jul. 3, 2015 (JP) 2015-134301

(51) Int. Cl. G06F 3/06

(52) U.S. Cl. CPC G06F 3/0631; G06F 3/0604; G06F 3/0673

(57) ABSTRACT

A non-transitory, computer-readable recording medium having stored therein a program for causing a computer to execute a complier process includes allocating a first information storage area, in which to store a data type of a first variable included in first source code, in correspondence to a storage area, in which to store the first variable, and updating the data type stored in the first information storage area when the first variable is updated during execution of a first object made from the first source code, and making the data type capable of being acquired by an external program together with the first variable stored in the storage area.

### CROSS-REFERENCE TO RELATED APPLICATION

This application is based upon and claims the benefit of priority of the prior Japanese Patent Application No. 2015-134301, filed on Jul. 3, 2015, the entire contents of which are incorporated herein by reference.

### FIELD

The embodiment discussed herein is related to a compilation apparatus and a compilation method.

### BACKGROUND

In common business-oriented language (COBOL), a plurality of data types are prepared as in JAVA (trademark) and other languages. Data types are used to classified data handled in a programming language into some types. Data types stipulate, for example, an encoding format and a data size when the data is stored in a memory. Specifically, data types include an integer type, a floating-point type, and a character type.

Restrictions on values that can be stored in data types in COBOL are not exactly determined. This is unlike data types in JAVA and the like. In COBOL, therefore, an alphanumeric item type (also referred to below as the X item), which is a data type that stores an alphanumeric item (value including only alphanumeric characters), for example, can store not only an alphanumeric item but also binary data or the like (see Japanese Patent Laid-open No. 2010-86218 and Japanese Patent Laid-open No. 2002-342078).

When object code (also referred to below as “COBOL code”) made by using COBOL compiler is executed, the COBOL code may call a function included in object code in another language such as, for example, JAVA (object code in JAVA will also be referred to below as “JAVA code”). Therefore, a computer that executes COBOL code can use functions provided by code in another language such as JAVA code.

When calling a function or the like included in JAVA code, COBOL code passes the value of the relevant data item (also referred to below as a variable) to the JAVA code, assuming that the value of the data item corresponds to a data type validated when the data item was declared.

However, data items in COBOL are such that restrictions on values that can be stored in data types are not exactly determined as described above. In a data item included in the COBOL code, therefore, a value corresponding to a data type different from the data type validated when the data item was declared may have been stored. In this case, the JAVA code fails to perform processing according to the current data type (also referred to below as the actual data type) of the value stored in the data item.

An object in one aspect is to perform compilation that enables processing based on the actual data type of a data item.

### SUMMARY

According to an aspect of the embodiments, a non-transitory, computer-readable recording medium having stored therein a program for causing a computer to execute a complier process includes allocating a first information storage area, in which to store a data type of a first variable included in first source code, in correspondence to a storage area, in which to store the first variable, and updating the data type stored in the first information storage area when the first variable is updated during execution of a first object made from the first source code, and making the data type capable of being acquired by an external program together with the first variable stored in the storage area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the whole structure of an information processing system;

FIG. 2 illustrates a specific example of source code in COBOL;

FIG. 3A illustrates information included in COBOL code generated from the source code in FIG. 2;

FIG. 3B illustrates the state of a memory in an information processing apparatus when the source code in FIG. 2 has been compiled;

FIG. 4 illustrates a state entered after processing has been executed in response to ‘MOVE “ABCD” TO P1.’ in the source code in FIG. 2;

FIG. 5 illustrates a case in which processing has been executed in response to ‘CALL “FUNC” USING P1 RETURNING R1.’ in the source code in FIG. 2;

FIG. 6 illustrates a case in which processing has been executed in response to ‘CALL “FUNC” USING P1 RETURNING R1.’ in the source code in FIG. 2;

FIG. 7 illustrates a case in which processing has been executed in response to ‘CALL “FUNC” USING P1 RETURNING R1.’ in the source code in FIG. 2;

FIG. 8 illustrates a case in which processing has been executed in response to ‘CALL “FUNC” USING P1 RETURNING R1.’ in the source code in FIG. 2;

FIG. 9 illustrates a specific example of source code in COBOL;

FIG. 10 illustrates a case in which processing has been executed in response to one ‘CALL “FUNC” USING P1.’ in the source code in FIG. 9;

FIG. 11 illustrates a case in which processing has been executed in response to another ‘CALL “FUNC” USING P1.’ in the source code in FIG. 9;

FIG. 12 illustrates the hardware structure of the information processing apparatus;

FIG. 13 is a functional block diagram of the information processing apparatus in FIG. 12;

FIG. 14 is a flowchart that outlines compilation processing in a first embodiment;

FIG. 15 is a flowchart that details compilation processing in the first embodiment;

FIG. 16 is a flowchart that illustrates object execution processing in the first embodiment;

FIG. 17 is a flowchart that illustrates object execution processing in the first embodiment;

FIG. 18 is a flowchart that illustrates object execution processing in the first embodiment;

FIG. 19 illustrates a specific example of source code in COBOL;

FIG. 20 illustrates a case in which the source code in FIG. 19 has been compiled;

FIG. 21 illustrates a case in which the source code in FIG. 19 has been compiled;

FIG. 22 illustrates a case in which processing has been executed in response to ‘MOVE “ABCD” TO P1.’ in the source code in FIG. 19;

FIG. 23 illustrates a case in which processing has been executed in response to ‘MOVE “EFG” TO P1.’ in the source code in FIG. 19;

FIG. 24 illustrates a case in which processing has been executed in response to ‘CALL “FUNC” USING P1 RETURNING R1.’ in the source code in FIG. 19;

FIG. 25 illustrates a case in which processing has been executed in response to ‘CALL “FUNC” USING P1 RETURNING R1.’ in the source code in FIG. 19;

FIG. 26 illustrates a case in which processing has been executed in response to ‘CALL “FUNC” USING P1 RETURNING R1.’ in the source code in FIG. 19; and

FIG. 27 illustrates a case in which processing has been executed in response to ‘CALL “FUNC” USING P1 RETURNING R1.’ in the source code in FIG. 19.

### DESCRIPTION OF EMBODIMENTS

Structure of an Information Processing System

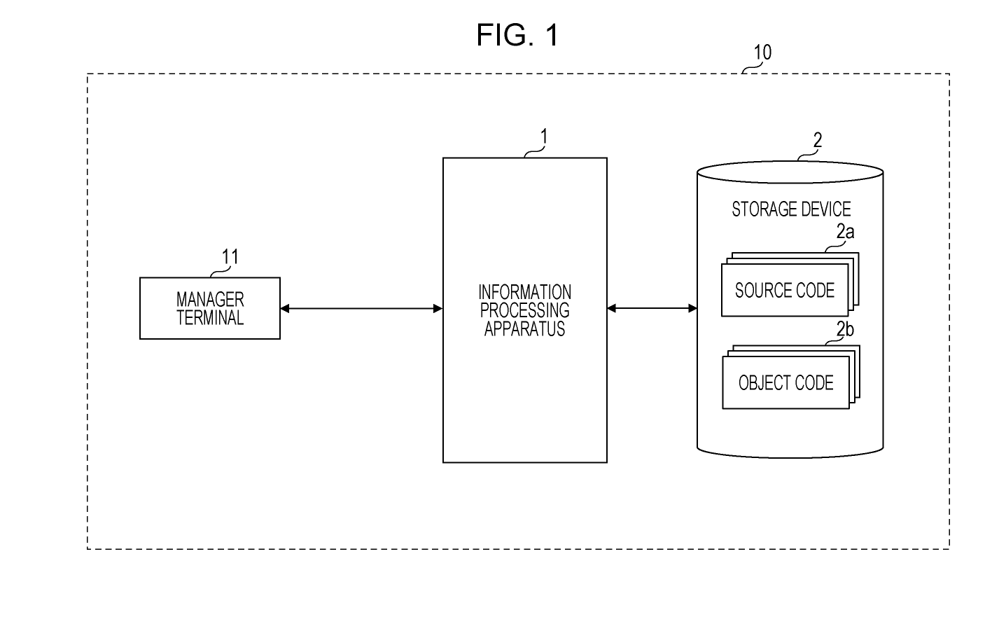

FIG. 1 illustrates the whole structure of an information processing system 10. The information processing system 10 in FIG. 1 has an information processing apparatus 1 (also referred to below as the compilation apparatus 1 or computer 1), a storage device 2, and a manager terminal 11.

When a system manager (also simply referred to below as the manager) enters a command to compile source code 2a, the information processing apparatus 1 compiles the source code 2a stored in the storage device 2 and generates object code 2b. Then, the information processing apparatus 1 stores the generated object code 2b in, for example, the storage device 2. After that, when, for example, the manager enters a command to execute the object code 2b, the information processing apparatus 1 executes the object code 2b stored in the storage device 2.

The manager may use the manager terminal 11 to enter a command into the information processing apparatus 1. The information processing apparatus 1 may autonomously perform the compilation of the source code 2a and the execution of the object code 2b when a preset time is reached.

Source Code in COBOL

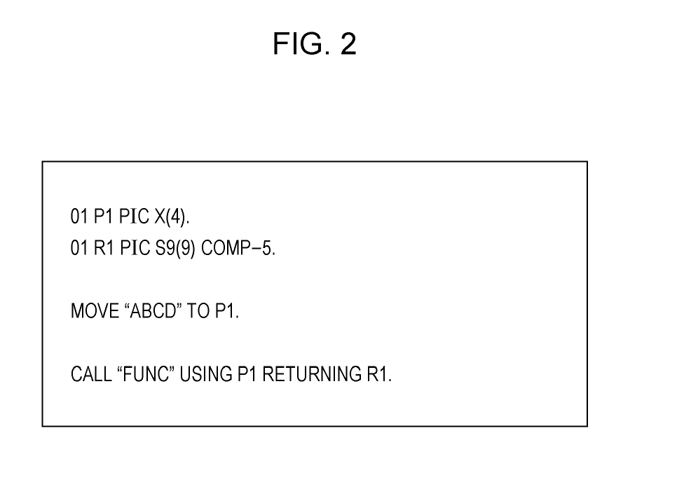

Next, source code written in COBOL will be described. FIG. 2 illustrates a specific example of source code in COBOL

In the source code illustrated in FIG. 2, ‘01 P1 PIC X(4).’ is a description indicating that a data item P1 that has an alphanumeric item type as the data type and has a data length (also referred to below as the area data length) of four bytes (four alphanumeric characters) will be defined during the execution of the COBOL code. In the source code illustrated in FIG. 2, ‘01 R1 PIC S9(9) COMP-5.’ is a description indicating that a data item R1 that has a signed numeric item type (a numeric item type is a data type in which a numeric value is stored) as the data type and is a signed four-byte integer (with nine orders of magnitude) from −999999999 to 999999999 will be defined during the execution of the COBOL code. COMP-5 is a description indicating that the value stored in the data item R1 will be processed as binary data.

In the source code illustrated in FIG. 2, ‘MOVE “ABCD” TO P1.’ is a description indicating a function that stores ABCD in the data item P1 during the execution of the COBOL code. In the source code illustrated in FIG. 2, ‘CALL “FUNC” USING P1 RETURNING R1.’ is a description indicating a function that calls a function FUNC by using the value (ABCD) of the data item P1 as an argument and stores a return value from the called function in the data item R1. In the description below, it will be assumed that the function FUNC is included in object code in a language other than COBOL (such object code will also be referred below as non-COBOL code and such a language will also be referred to below as non-COBOL).

Compilation of Source Code in COBOL

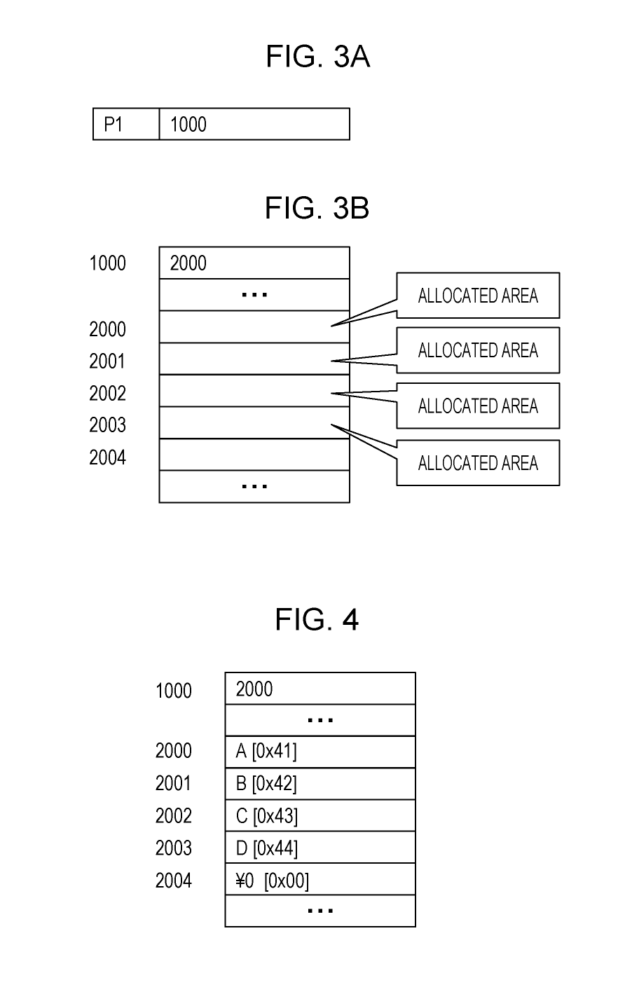

Next, compilation of the source code illustrated in FIG. 2 will be described. FIGS. 3A and 3B explain a case in which the source code illustrated in FIG. 2 has been compiled. Specifically, FIG. 3A illustrates information included in COBOL code generated from the source code in FIG. 2, and FIG. 3B illustrates the state of a memory in the information processing apparatus 1 when the source code in FIG. 2 has been compiled.

When the source code in FIG. 2 is compiled, the information processing apparatus 1 (compilation apparatus 1) references ‘01 P1 PIC X(4).’ and allocates a four-byte area as an area in which the value of the data item P1 can be stored (the area will also be referred to as the area for the data item P1). Specifically, as illustrated in, for example, FIG. 3B, the information processing apparatus 1 allocates an area, in the memory of the information processing apparatus 1, starting from an area at address 2000 and continuing to an area at address 2003 as the area for the data item P1. As illustrated in, for example, FIG. 3B, the information processing apparatus 1 then stores information indicating 2000, which is the first address of the area for the data item P1, in an area at address 1000 in the memory of the information processing apparatus 1. Furthermore, as illustrated in, for example, FIG. 3A, the information processing apparatus 1 compiles the source code in FIG. 2 to generate COBOL code so that information is included, the information indicating that the address of the area in which the first address of the area for the data item P1 is stored is 1000.

Thus, while being executed, the COBOL code generated from the source code in FIG. 2 can acquire the value stored in the data item P1 by using the address of the area in which the first address of the area for the data item P1 is stored. Processing performed by the information processing apparatus 1 with reference to ‘01 R1 PIC S9(9) COMP-5.’ is the same as described with reference to FIGS. 3A and 3B, so the description of the processing will be omitted.

Execution of COBOL Code

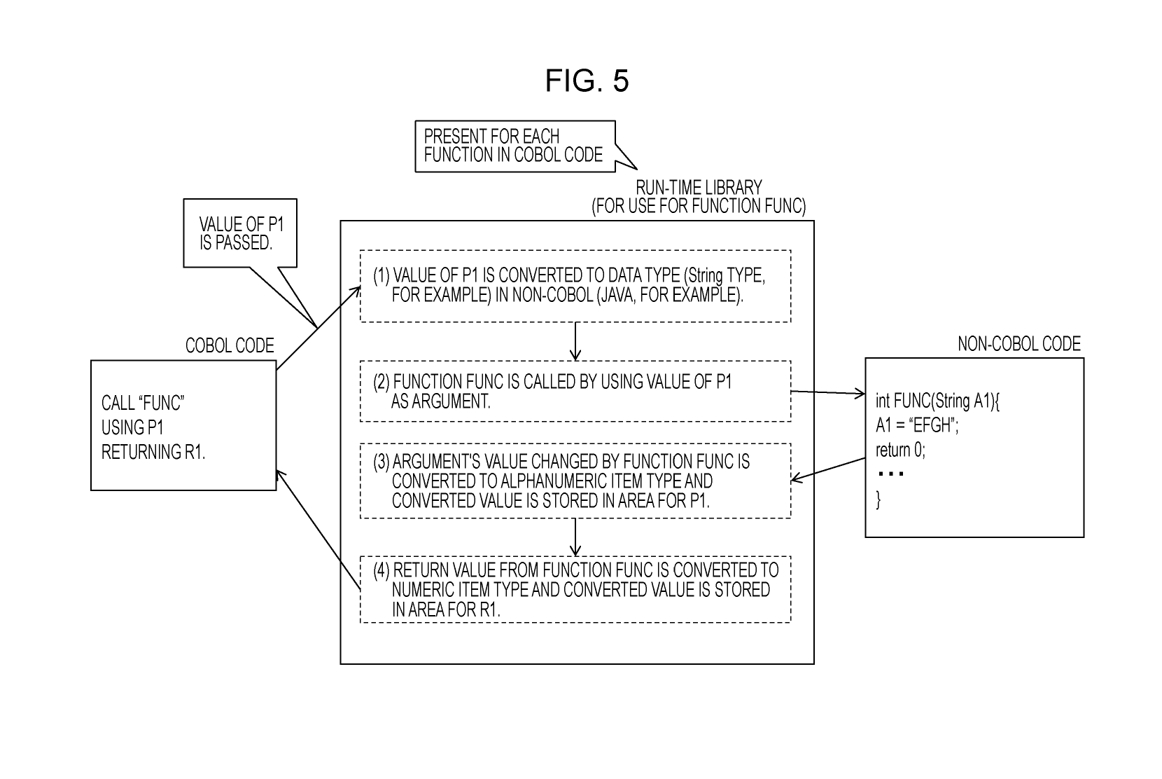

Next, the state of the memory in the information processing apparatus 1 will be described in a case in which the COBOL code generated from the source code in FIG. 2 has been executed. FIG. 4 illustrates a case in which processing has been executed in response to ‘MOVE “ABCD” TO P1.’ in the source code in FIG. 2. FIGS. 5 to 8 illustrate cases in which processing has been executed in response to ‘CALL “FUNC” USING P1 RETURNING R1.’ in the source code in FIG. 2;

When processing is executed in response to ‘MOVE “ABCD” TO P1.’ in the source code in FIG. 2, the COBOL code (CPU in the information processing apparatus 1 that operates in cooperation with the COBOL code) stores values indicating ABCD in the area for the data item P1, as illustrated in FIG. 4. Thus, the COBOL code can retain the value of the data item P1 in the memory in the information processing apparatus 1.

In the example in FIG. 4, the character codes of the values (indicating ABCD) stored in the area for the data item P1 are in American Standard Code for Information Interchange (ASCII) format. In the example in FIG. 4, \0 (NULL) is stored in an area at address 2004 to indicate the end of the values (indicating ABCD) stored in the area at addresses from 2000 to 2003.

Next, when processing is executed in response to ‘CALL “FUNC” USING P1 RETURNING R1.’ in the source code in FIG. 2, the COBOL code requests (commands) a non-COBOL object to execute the function FUNC.

In this case, the COBOL code converts the value of the data item P1 to, for example, a format that the non-COBOL code can recognize. The COBOL code then uses the converted value as an argument to request the non-COBOL code to execute the function FUNC. A case will be described below in which COBOL code requests non-COBOL code to execute the function FUNC.

FIG. 5 illustrates a case in which COBOL code requests non-COBOL code to execute the function FUNC. As illustrated in FIG. 5, the COBOL code executes a run-time library, which is a program stored in the storage device 2 or the like, to convert the value stored in the data item P1 to a format that the non-COBOL code can recognize. In the description below, it will be assumed that non-COBOL code is JAVA code.

A run-time library is a program that converts information (argument and return value) between COBOL code and non-COBOL code. In the example in FIG. 5, a run-time library is present for each function included in the COBOL code. In the example in FIG. 5, therefore, when calling the function FUNC included in the non-COBOL code, the COBOL code passes the value of the data item P1 to a run-time library corresponding to the function FUNC.

When the run-time library (CPU in the information processing apparatus 1 that operates in cooperation with the run-time library) receives the value of the data item P1, as illustrated in, for example, FIG. 5, the run-time library converts the received value of the data item P1 to, for example, a String type, which is a data type in JAVA ((1) in FIG. 5). That is, the run-time library converts the value of the data item P1 to a format that the non-COBOL code (JAVA code) can recognize by converting the value of the data item P1 to the String type. The run-time library then uses the value converted to the String type as an argument to call the function FUNC ((2) in FIG. 5).

After that, the run-time library waits until it receives an execution result of the function FUNC (an argument's value changed by the function FUNC and a return value from it, for example) from the non-COBOL code. The return value from the function FUNC is used as a value that indicates whether the function FUNC has been executed normally. In the example in FIG. 5, the data type of the return value that the function FUNC passes to the run-time library is the int type, which is the numeric type in JAVA.

Upon receipt of the execution result of the function FUNC, the run-time library converts the argument's value changed by the function FUNC to the alphanumeric item type and stores the converted value in the area for the data item P1 as illustrated in, for example, FIG. 5 ((3) in FIG. 5). In this case, the run-time library converts the return value to the numeric item type and stores the converted value in the area for the data item R1 ((4) in FIG. 5).

State of the Memory During Execution of COBOL Code

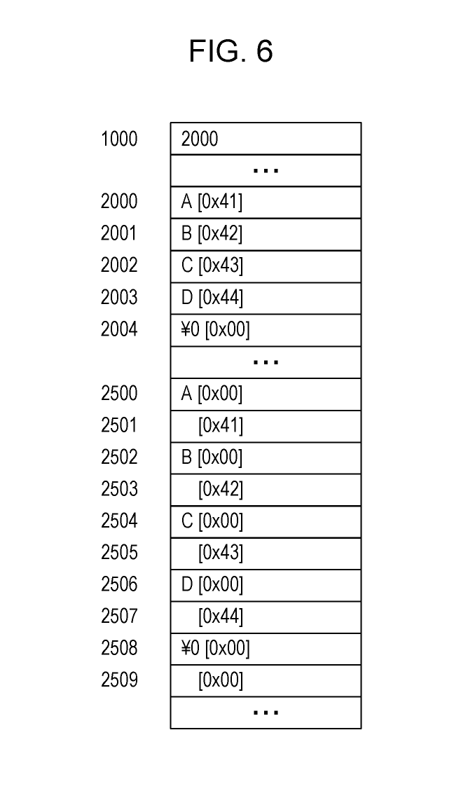

Next, changes in the state of the memory during the execution of the processing described with reference to FIG. 5 will be described. FIGS. 6 to 8 illustrate changes in the state of the memory during the execution of the processing described with reference to FIG. 5.

As illustrated in FIG. 6, when the value of the data item P1 has been converted to a format that the non-COBOL code can recognize ((1) in FIG. 5), the run-time library stores the converted value in the memory in the information processing apparatus 1.

Specifically, in the example in FIG. 6, the run-time library converts the character codes of ABCD, which is value of the data item P1, from ASCII to Unicode. The run-time library then stores the value converted to Unicode in an area starting from address 2500 in the memory in the information processing apparatus 1, as illustrated in FIG. 6. The area in which the run-time library stores the converted value (area starting from address 2500) may be allocated during the compilation of the COBOL source code, as described with reference to FIGS. 3A and 3B.

Next, in the example in FIG. 6, the non-COBOL code (CPU in the information processing apparatus 1 that operates in cooperation with the non-COBOL code) acquires an argument used to execute processing of the function FUNC with reference the area starting from address 2500 ((2) in FIG. 5). As illustrated in, for example, FIG. 5, the non-COBOL code then stores the value of the acquired argument in a variable A1 and executes the function FUNC according to the stored value of the variable A1.

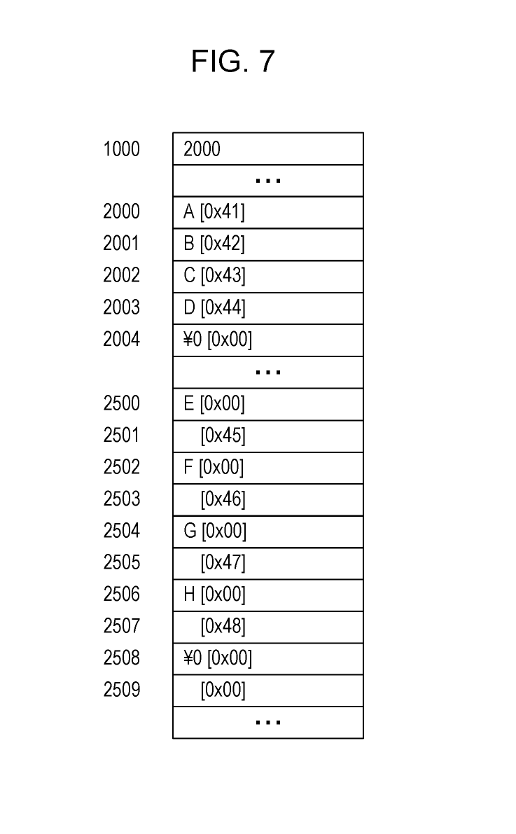

After that, the non-COBOL code stores the argument (EFGH), which has been changed by the function FUNC in an area starting from address 2500 in the memory in the information processing apparatus 1, as illustrated in FIG. 7.

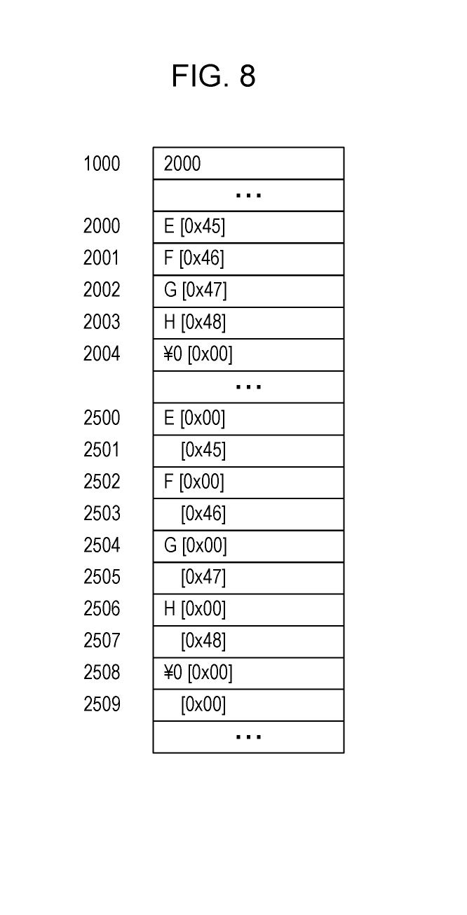

In this case, the run-time library converts the value of the argument that the non-COBOL code has stored to the alphanumeric item type, which is a data type that the COBOL code can recognize, as illustrated in FIG. 8. The run-time library stores the value of the converted argument in an area starting from address 2000 (area for the data item P1).

Specifically, the run-time library converts the character codes of EFGH, which is the value of the argument converted by the function FUNC, from Unicode to ASCII. The run-time library then stores the values converted to ASCII in the area starting from address 2000 in the memory in the information processing apparatus 1, as illustrated in FIG. 8.

A specific example of storing a return value from the function FUNC in the memory in the information processing apparatus 1 will be omitted because the specific example is similar to a specific example of storing the value of an argument changed by the function FUNC in the memory in the information processing apparatus 1.

When the COBOL code calls the function FUNC, the run-time library converts the value of the data item P1 according to the data type validated when the data item P1 was declared. In a data item in COBOL code, a value of a data type different from the data type validated when the data item was declared may have been stored. A case will be described in which a value of a data type different from the data type validated when the data item was declared has been stored.

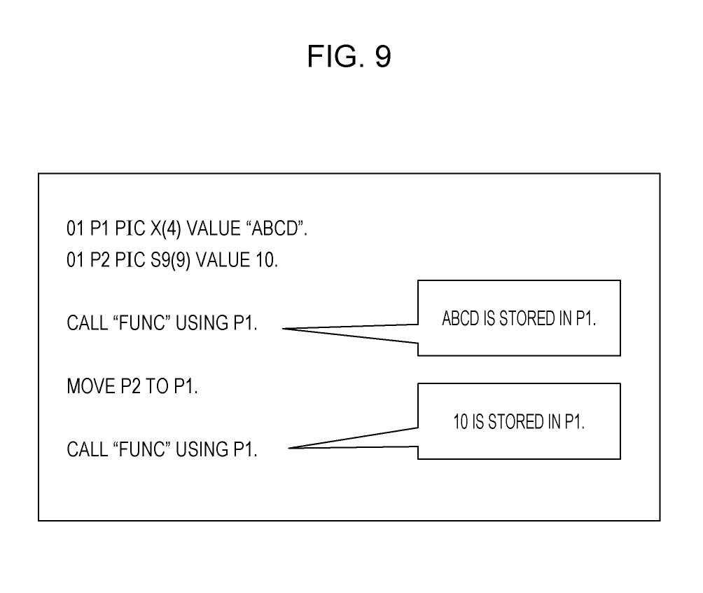

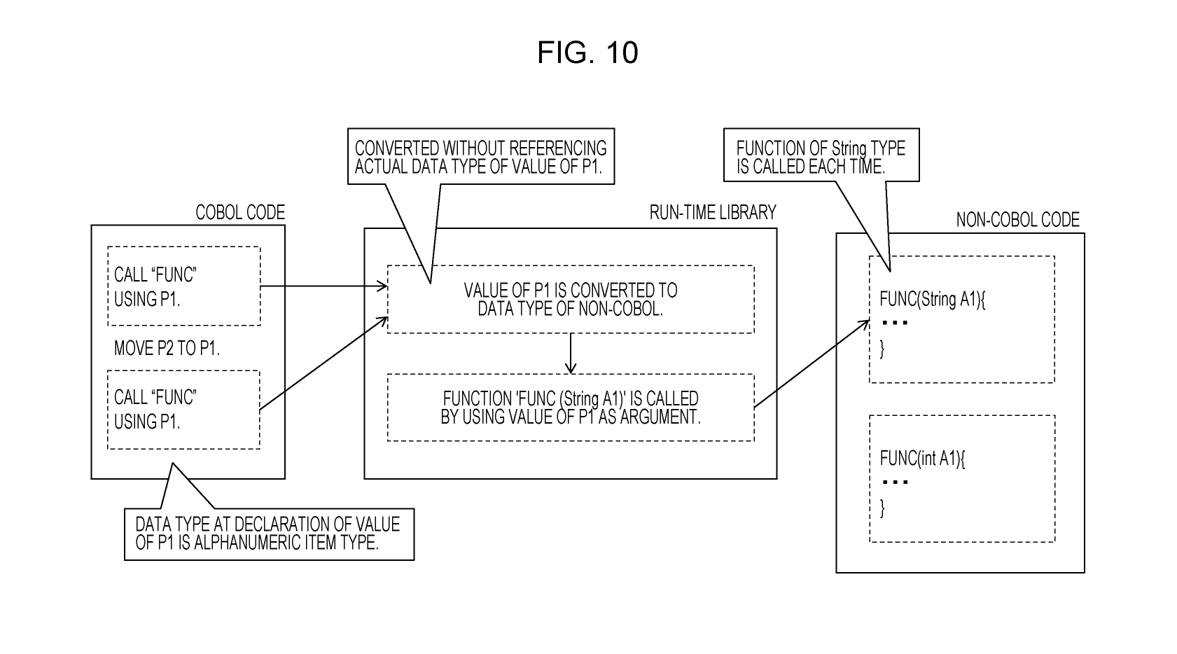

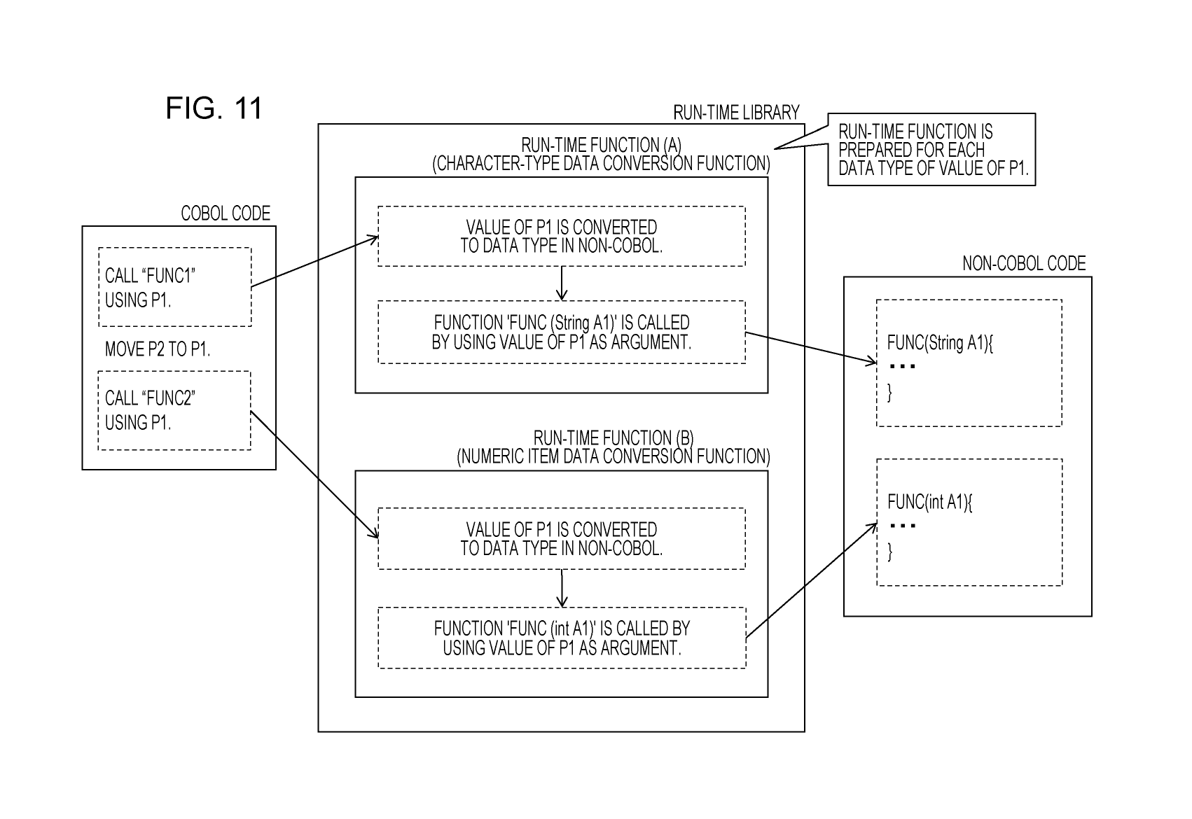

FIG. 9 illustrates a specific example of source code in COBOL. FIGS. 10 and 11 each illustrate a case in which processing has been executed in response to the relevant ‘CALL “FUNC” USING P1.’ in the source code in FIG. 9.

In the source code illustrated in FIG. 9, ‘01 P1 PIC X(4) VALUE “ABCD”.’ is a description indicating that the data item P1 that has an alphanumeric item type as the data type and has an area data length of four bytes (four alphanumeric characters) will be defined during the execution of the COBOL code. This description also indicates that ABCD will be stored in the data item P1 as an initial value. In the source code illustrated in FIG. 9, ‘01 P2 PIC S9(9) VALUE 10.’ is a description indicating that a data item P2 that has a signed numeric item type as the data type and is a signed four-byte integer (with nine orders of magnitude) from −999999999 to 999999999 will be defined during the execution of the COBOL code. This description also indicates that 10 will be stored in the data item P2 as an initial value.

In the source code illustrated in FIG. 9, a first ‘CALL “FUNC” USING P1.’ is a description indicating a function that calls the function FUNC by using the value (ABCD) of the data item P1 as an argument. In the source code illustrated in FIG. 9, ‘MOVE P2 TO P1.’ is a description indicating a function that stores the value (10) of the data item P2 in the data item P1 during execution of COBOL code. In the source code illustrated in FIG. 9, a second ‘CALL “FUNC” USING P1.’ is a description indicating a function that calls the function FUNC by using the value (10) of the data item P1 as an argument.

Next, with reference to FIGS. 10 and 11, a case will be described in which processing is executed in response to each ‘CALL “FUNC” USING P1.’ in the source code in FIG. 9.

As illustrated in FIG. 10, the run-time library converts the value stored in the data item P1 according to the data type (alphanumeric item type) validated when the data item P1 was declared. That is, in this case, the run-time library converts the value of the data item P1 without referencing the actual data type of the value that is currently stored in the data item P1. Therefore, each time the run-time library executes processing in response to ‘CALL “FUNC” USING P1.’, the run-time library calls ‘FUNC (String A1)’ corresponding to the data type (alphanumeric item type) validated when the data item P1 was declared. As illustrated in FIG. 10, therefore, even if the non-COBOL code includes a function ‘FUNC (int A1)’, the run-time library does not call functions other than the function ‘FUNC (String A1)’. That is, in this case, the information processing apparatus 1 fails to utilize the characteristics of COBOL that restrictions on values that can be stored in data types are not exactly determined.

However, even if identical functions are coded, a developer of source code in COBOL (also simply referred to below as the developer) may prepare a different conversion function for each data type, at the time of execution, of the value of the data item P1, as illustrated in FIG. 11.

In this case, the developer changes the first ‘CALL “FUNC” USING P1.’ in the source code in FIG. 9 to ‘CALL “FUNC1” USING P1.’ as illustrated in FIG. 11. The developer also changes the second ‘CALL “FUNC” USING P1.’ in the source code in FIG. 9 to ‘CALL “FUNC2” USING P1.’ as illustrated in FIG. 11.

The developer further prepares a run-time library (A) (character-type data conversion function) that calls the function ‘FUNC (String A1)’ as a run-time library corresponding to ‘CALL “FUNC1” USING P1.’. The developer also prepares a run-time library (B) (numeric item data conversion function) that calls the function ‘FUNC (int A1)’ as a run-time library corresponding to ‘CALL “FUNC2” USING P1.’.

The developer then makes a setting so that the run-time library (A) converts the value of the data item P1 passed from ‘CALL “FUNC1” USING P1.’. The developer also makes a setting so that the run-time library (B) converts the value of the data item P1 passed from ‘CALL “FUNC2” USING P1.’. Therefore, when each function included in the COBOL code is called, the COBOL code can call a function included in the non-COBOL code according to the actual data type of the value of the data item P1.

In the example illustrated in FIG. 11, however, each time the non-COBOL code (source code in non-COBOL) is changed, changes in the COBOL code (source code in COBOL) and a run-time library corresponding to the changed portion are involved. This increases a load on the developer, the load being involved in changes in the non-COBOL code.

In view of this, the information processing apparatus 1 in this embodiment allocates an area in which to store information about a data type of a data item (also referred to below as the first variable) included in source code in COBOL (the source code will also be referred to below as the first source code) during compilation of the first source code). If the value of the first variable is updated during the execution of COBOL code made from the first source code (the COBOL code will also referred to below as the first object), the information processing apparatus 1 stores information about the data type (actual data type) of the first variable, the value of which has been updated, together with the updated value of the first variable. That is, when compiling the first source code, the information processing apparatus 1 allocates not only an area in which to store the value of the first variable but also an area in which to store information about the data type of the first variable.

Thus, when the first object calls a function included in non-COBOL code made from source code in non-COBOL (the non-COBOL code will also be referred to below as the second object and the source code in non-COBOL will also be referred to below as the second source code), the information processing apparatus 1 can acquire the information about the actual data type of the first variable. Therefore, the information processing apparatus 1 can convert the first variable, which is an argument used to execute a function included in the second object, to a format that the second object can recognize, according to the information about the actual data type of the acquired first variable. That is, when converting the value of the first variable passed from the first object to a format that the second object can recognize, the developer may not prepare a plurality of run-time libraries, each of which corresponds to one data type of the value of the first variable.

The information processing apparatus 1 also allocates an area in which to store the value of the first variable and an area in which to store the information about the data type of the first variable in, for example, the memory in the information processing apparatus 1. This enables an external program (run-time program or second object) to acquire the value of the first variable and the information about the data type of the first variable with reference to the memory in the information processing apparatus 1.

Hardware Structure of the Information Processing Apparatus

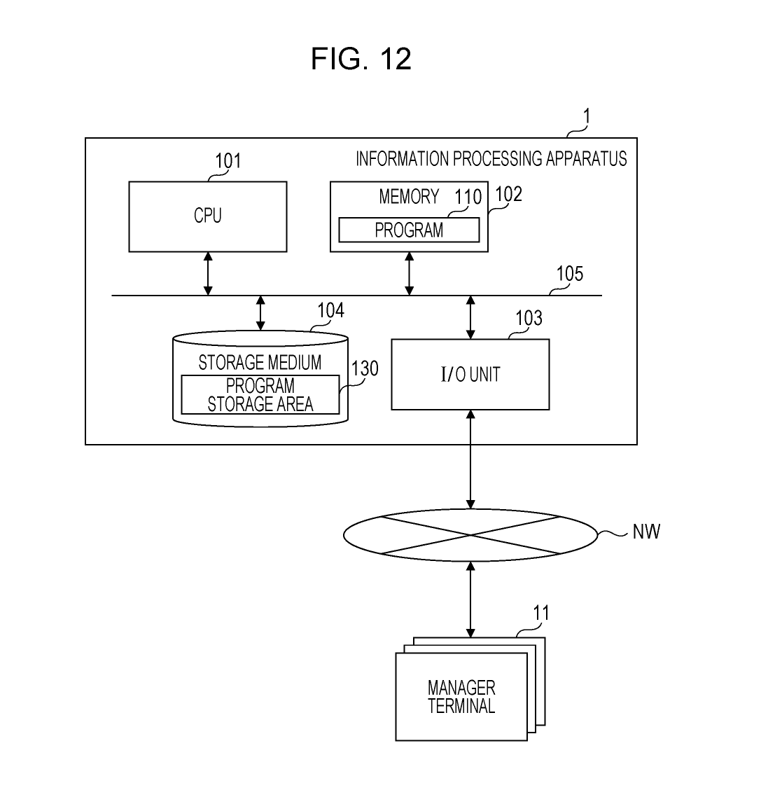

Next, the hardware structure of the information processing apparatus 1 will be described. FIG. 12 illustrates the hardware structure of the information processing apparatus 1.

The information processing apparatus 1 has a central processing unit (CPU) 101, which is a processor, a memory 102, an external interface (I/O unit) 103, and a storage medium (storage) 104. These components are mutually connected through a bus 105.

The storage medium 104 stores a program 110 (also referred to below as the compiler 110) used to, for example, perform processing to compile source code in COBOL (the processing will also be referred to below as compilation processing) in a program storage area 130 (also referred to below as the storage section 130 or PG storage area 130) in the storage medium 104.

The first source code, second source code, first object, and second object described above, for example, are stored in the program storage area 130. The storage device 2 referenced in FIG. 1 and other drawings may correspond to, for example, the program storage area 130.

When the program 110 is executed, the CPU 101 loads the program 110 from the storage medium 104 into the memory 102 as illustrated in FIG. 12 and performs compilation processing in cooperation with the program 110.

The external interface 103 may be connected to the manager terminal 11 by communication through a network NW. As a display, the manager terminal 11 may be connected directly to the external interface 103.

Software Structure of the Information Processing Apparatus

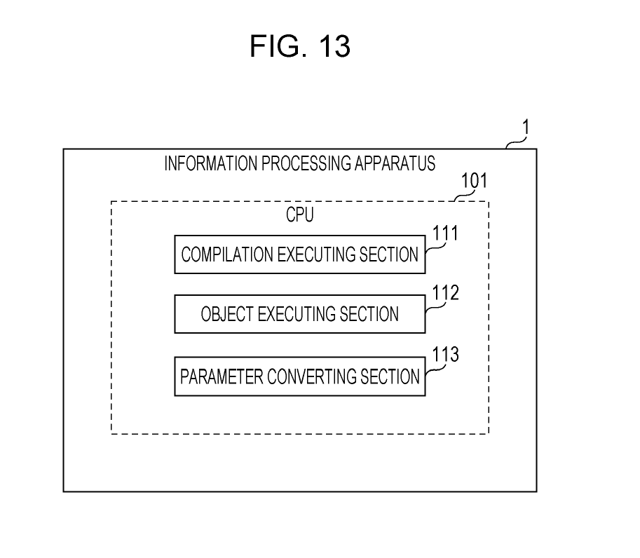

Next, the software structure of the information processing apparatus 1 will be described. FIG. 13 is a functional block diagram of the information processing apparatus 1 in FIG. 12. The CPU 101 operates as a compilation executing section 111 (also referred to below as the area allocating section 111) and an object executing section 112 in cooperation with the program 110. The CPU 101 also operates as a parameter converting section 113 (also referred to below as the run-time library 113) in cooperation with the program 110.

The compilation executing section 111 performs compilation processing for, for example, the first source code and second source code stored in the program storage area 130. The first object is made from the first source code and the second object is made from the second source code. Specifically, the compilation executing section 111 may perform compilation processing for the first source code or second source code in response to an input that commands the execution of compilation processing, the input being entered by the manager through the manager terminal 11. The compilation executing section 111 then stores, for example, the first object and second object into the program storage area 130.

During the execution of compilation processing, the compilation executing section 111 allocates a variable storage area 102a, in which to store the first variable included in the first source code, in the memory 102. During the execution of compilation processing, the compilation executing section 111 also allocates an information storage area 102b (also referred to below as the first information storage area 102b), in which to store the actual data type of the first variable, in the memory 102 in the information processing apparatus 1, in correspondence to the variable storage area 102a. During the execution of compilation processing, the compilation executing section 111 further allocates an information storage area 102c (also referred to below as the second information storage area 102c), in which to store the data type of the second variable, in the memory 102 in the information processing apparatus 1, in correspondence to the variable storage area 102a. Specific examples of the variable storage area 102a, first information storage area 102b, and second information storage area 102c will be described later.

The data type of the first variable is a data type (alphanumeric item type, for example) corresponding to the value of the first variable. If no value is stored in the first variable, the data type of the first variable is the data type validated when the first variable was declared. The effective data length of the first variable is the data length of an area in which information other than spaces is stored in the area for the first variable, the effective data length of the first variable being part of the area data length of the first variable. The data type and effective data length of the first variable are updated when the first variable is updated during the execution of the first object. The data type and effective data length of the first variable are acquired by an external program (second object or parameter converting section 113, which will be described later, for example) together with the value of the first variable. Specific examples of the variable storage area 102a, first information storage area 102b, and second information storage area 102c will be described later.

The object executing section 112 executes the first object and second object stored in the program storage area 130. Specifically, the object executing section 112 may execute the first object or second object in response to, for example, an input that commands the execution of the first object or second object, the input being entered by the manager through the manager terminal 11. Processing in which the object executing section 112 executes the first object or second object will also be referred to below as object execution processing.

When the first object requests the execution of the second object (function included in the second object), the parameter converting section 113 converts the first variable to a format that the second object can recognize, with reference to information about the data type of the first variable. Specifically, the parameter converting section 113 converts the value of the first variable from ASCII to Unicode so that the first variable is converted to a format that the second object can recognize.

The parameter converting section 113 also coverts an execution result (changed argument's value or return value) obtained in processing performed in response to the request from the first object to execute the second object to a format that the first object can recognize.

### First Embodiment

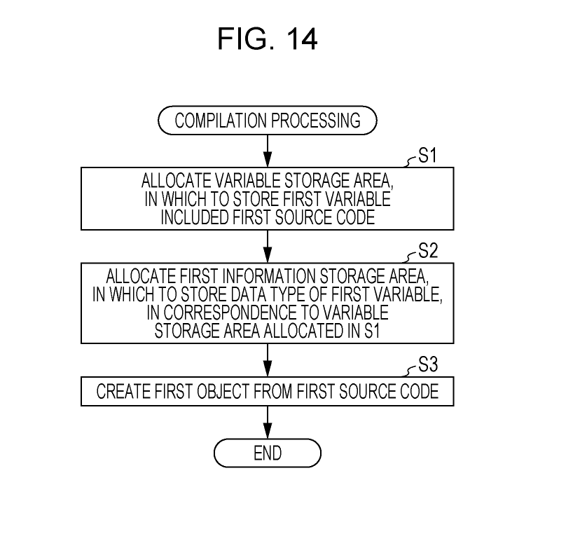

Next, a first embodiment will be outlined. FIG. 14 is a flowchart that outlines compilation processing in the first embodiment.

When compilation processing starts, the compilation executing section 111 in the information processing apparatus 1 allocates the variable storage area 102a, in which to store a first variable included in first source code (S1). The compilation executing section 111 then allocates the first information storage area 102b, in which to store the data type of the first variable, in correspondence to the variable storage area 102a allocated in S1 (S2). Specifically, the compilation executing section 111 allocates the variable storage area 102a and first information storage area 102b in an area that can be referenced from an external program (for example, in the memory 102 in the information processing apparatus 1). The compilation executing section 111 then may generate a first object from the first source code (S3).

Accordingly, when the object executing section 112 in the information processing apparatus 1 has updated the value of the first variable, the object executing section 112 can retain information about the data type of the updated value of the first variable in, for example, the memory 102 in the information processing apparatus 1 together with the updated value of the first variable, as described later. Therefore, when the first object calls a function included in the second object by using the first variable as an argument, the parameter converting section 113 in the information processing apparatus 1 can convert the value of the first variable with reference to the information about the data type of the value of the first variable.

Therefore, when converting the value of the first variable passed from the first object to a format that the second object can recognize, the developer may not prepare a plurality of run-time libraries, each of which corresponds to one data type of the value of the first variable.

Furthermore, the developer may not prepare the parameter converting section 113 in correspondence to the number of functions included in the second object and their types. Therefore, when a function included in the second object is changed, the developer may change neither the parameter converting section 113 nor the first source code.

The developer may prepare a run-time library that can covert each of the data types of the values of first variables, the values being likely to be passed from the first object, to a format that the second object can recognize (this type of run-time library will also be referred to below as a general-purpose run-time library). That is, when a value of the first variable is passed from the first object, the general-purpose run-time library acquires information about the data type of the value of the first variable. The general-purpose run-time library then converts the first variable's value passed from the first object to a format that the second object can recognize, according to information about the acquired data type. Thus, the developer can convert the first variable's value passed from the first object without preparing a run-time library for each function included in the first object.

Details of the First Embodiment

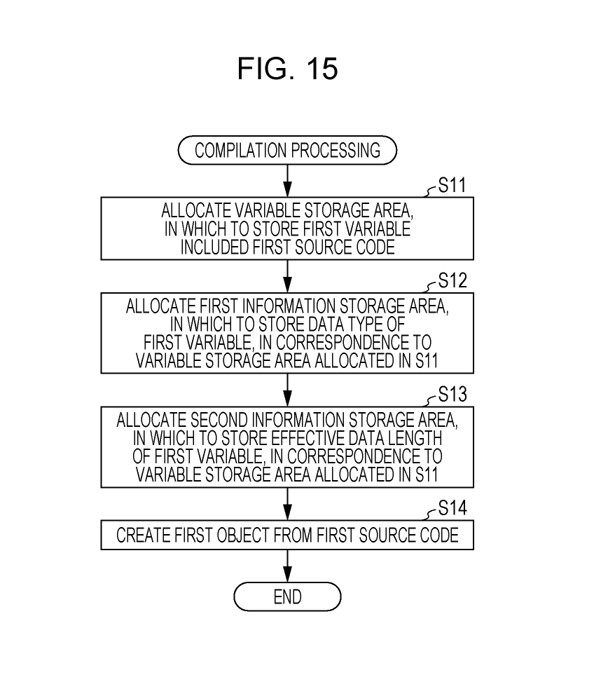

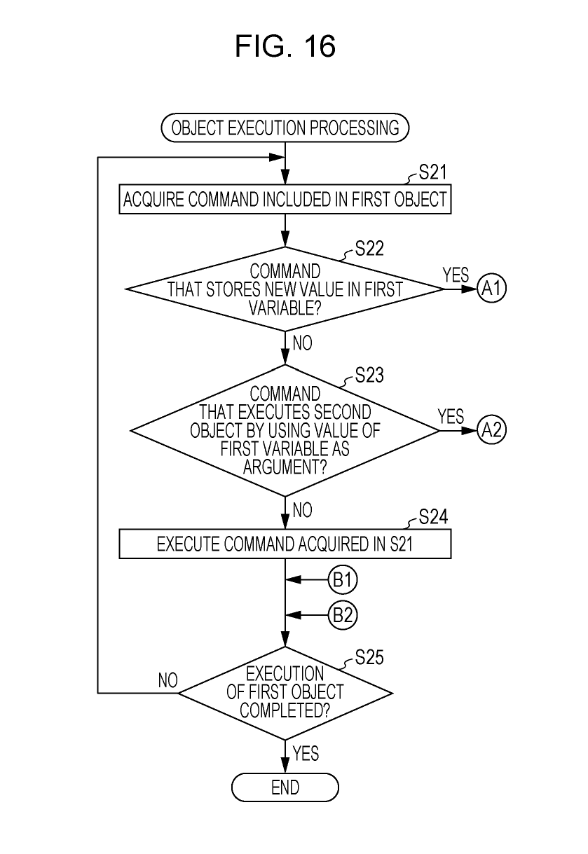

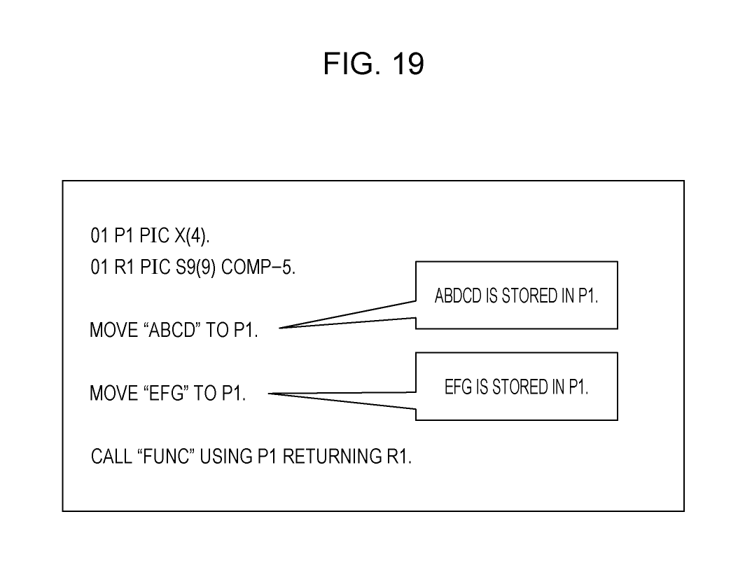

The first embodiment will be described below in detail. FIG. 15 is a flowchart that details compilation processing in the first embodiment. FIGS. 16 to 18 are each a flowchart that illustrates object execution processing in the first embodiment. FIGS. 19 to 27 illustrate details of compilation processing and object execution processing in the first embodiment. Compilation processing and object execution processing in FIGS. 15 to 18 will be described with reference to FIGS. 19 to 27.

Details of Compilation Processing

First, compilation processing in the first embodiment will be described in detail.

The compilation executing section 111 allocates the variable storage area 102a, in which to store the first variable included in the first source code, as illustrated in FIG. 15 (S11). The compilation executing section 111 then allocates the first information storage area 102b, in which to store the data type of the first variable, in correspondence to the variable storage area 102a allocated in S11 (S12).

Next, the compilation executing section 111 allocates the second information storage area 102c, in which to store the effective data length of the first variable, in correspondence to the variable storage area 102a allocated in S11 (S13).

That is, when the data type of the first variable at the time of its declaration is the fixed-length character type (alphanumeric item type), if the value of the first variable is shorter than the area data length, the COBOL code (first object) performs, during its execution, processing to store space-indicating information in an area that follows an area including the end of the value of the first variable. When the value of the first variable is passed from the first object to the parameter converting section 113, it performs processing to exclude the space-indicating information from the area that follows the area including the end of the value of the first variable, after which the parameter converting section 113 converts the first variable's value passed from the first object.

The parameter converting section 113 preferably identifies the area in which the space-indicating information has been stored (the area in which information to be excluded is stored) before the parameter converting section 113 converts the first variable's value passed from the first object. If, however, the area data length of the first variable is large, an increased processing load is applied to the parameter converting section 113 when it identifies the area in which the space-indicating information has been stored.

In view of this, the compilation executing section 111 in this embodiment allocates the second information storage area 102c, in which to store information about the effective data length of the first variable, before the compilation executing section 111 executes the compilation of the first object (S13). Then, the object executing section 112 retains the effective data length of the first variable together with the value of the first variable, as described later.

Therefore, the parameter converting section 113 can acquire information about the effective data length of the first variable before the parameter converting section 113 converts the first variable's value passed from the first object. The parameter converting section 113 thereby can identify the area in which the space-indicating information has been stored, according to the acquired information about the effective data length. This can suppress a processing load on the parameter converting section 113 from being increased when the parameter converting section 113 converts the first variable's value passed from the first object.

After that, the compilation executing section 111 generates the first object from the first source code (S14). Specific examples of S11 and S12 will be described below.

Specific Examples of S11 and S12

First, the source code in FIG. 19 will be described. FIG. 19 illustrates a specific example of source code in COBOL.

In the source code illustrated in FIG. 19, ‘01 P1 PIC X(4).’ is a description indicating that the data item P1 that has the alphanumeric item type as the data type and has an area data length of four bytes (four alphanumeric characters) will be defined when the COBOL code generated from the source code in FIG. 19 is executed. In the source code illustrated in FIG. 19, ‘01 R1 PIC S9(9) COMP-5.’ is a description indicating that the data item R1 that has a signed numeric item type as the data type and is a signed four-byte integer (with nine orders of magnitude) from −999999999 to 999999999 will be defined during the execution of the COBOL code.

In the source code illustrated in FIG. 19, ‘MOVE “ABCD” TO P1.’ is a description indicating a function that stores ABCD in the data item P1 during the execution of the COBOL code. In the source code illustrated in FIG. 19, ‘MOVE “EFG” TO P1.’ is a description indicating a function that stores EFG in the data item P1 during the execution of the COBOL code.

In the source code illustrated in FIG. 19, ‘CALL “FUNC” USING P1 RETURNING R1.’ is a description indicating a function that calls the function FUNC by using the value (EFG) of the data item P1 as an argument and stores a return value from the called function in the data item R1 during the execution of the COBOL code.

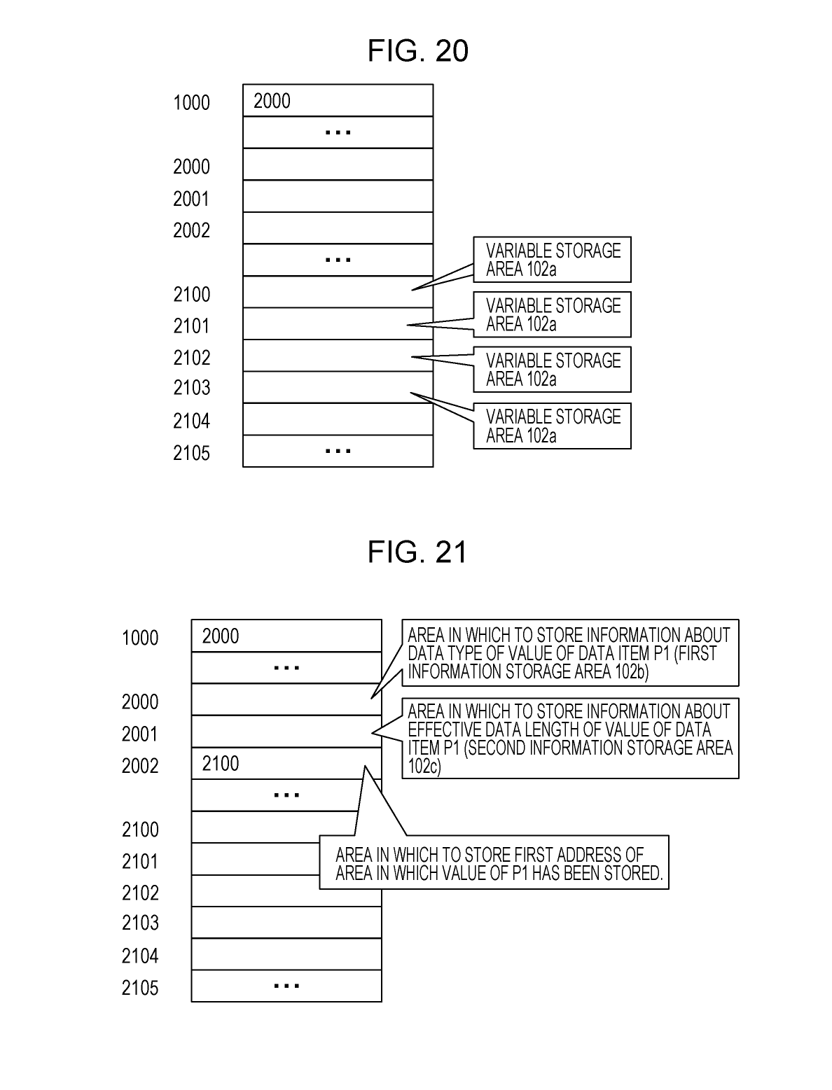

Next, changes in the state of the memory when the source code illustrated in FIG. 19 is compiled will be described. FIGS. 20 and 21 each illustrate a case in which the source code in FIG. 19 has been compiled.

When the source code in FIG. 19 is compiled, the compilation executing section 111 references ‘01 P1 PIC X(4).’ and allocates a four-byte area as an area for the data item P1.

Specifically, as illustrated in, for example, FIG. 20, the compilation executing section 111 allocates an area, in the memory of the information processing apparatus 1, starting from an area at address 2100 and continuing to an area at address 2103 as the area (variable storage area 102a) for the data item P1.

As illustrated in, for example, FIG. 21, the compilation executing section 111 also allocates an area at address 2000 in the memory in the information processing apparatus 1 as the area (first information storage area 102b) in which to store information about the data type of the value of the data item P1. As illustrated in FIG. 21, the compilation executing section 111 also allocates an area at address 2001 in the memory in the information processing apparatus 1 as the area (second information storage area 102c) in which to store information about the effective data length of the value of the data item P1. As illustrated in, for example, FIG. 21, the compilation executing section 111 further allocates an area at address 2002 in the memory 102 in the information processing apparatus 1 as the area in which to store the first address of the area in which the value of the data item P1 has been stored.

Thus, during the execution of the first object, the object executing section 112 can retain the actual data type of the first variable and its effective data length together with the value of the first variable, as described later.

Object Execution Processing

Next, object execution processing in the first embodiment will be described.

The object executing section 112 acquires a command included in the first object as illustrated in FIG. 16 (S21). The object executing section 112 then decides whether the command acquired in S21 is a command that stores a new value in the first variable (S22).

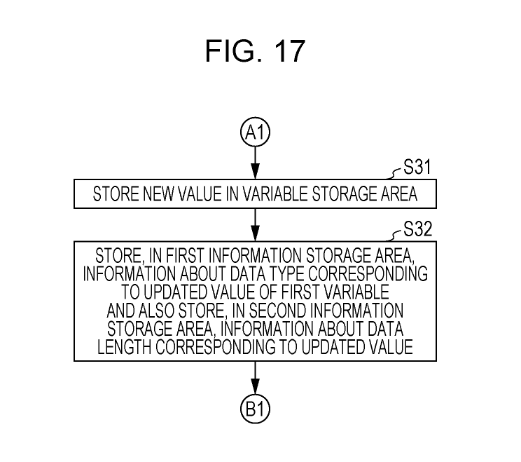

If the command acquired in S21 is a command that stores a new value in the first variable (the result in S22 is Yes), the object executing section 112 stores a new value in the variable storage area 102a (S31) as illustrated in FIG. 17. The object executing section 112 further stores, in the first information storage area 102b, information about the data type corresponding to the updated value of the first variable and also stores, in the second information storage area 102c, information about the effective data length corresponding to the updated value (S32). Specific examples of S31 and S32 will be described below.

Specific examples of S31 and S32

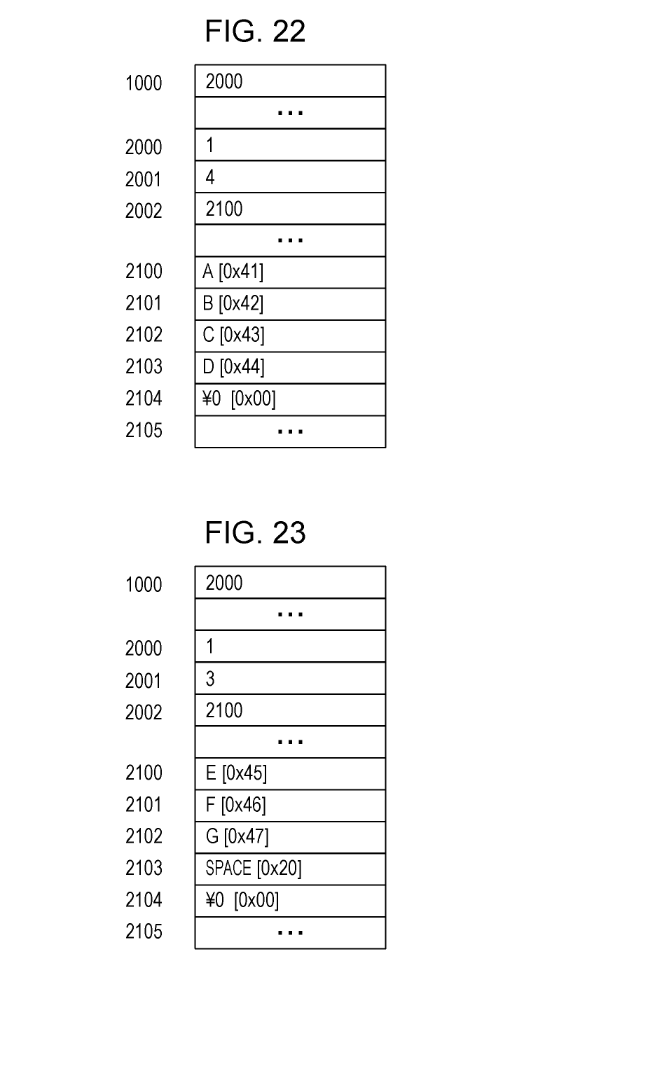

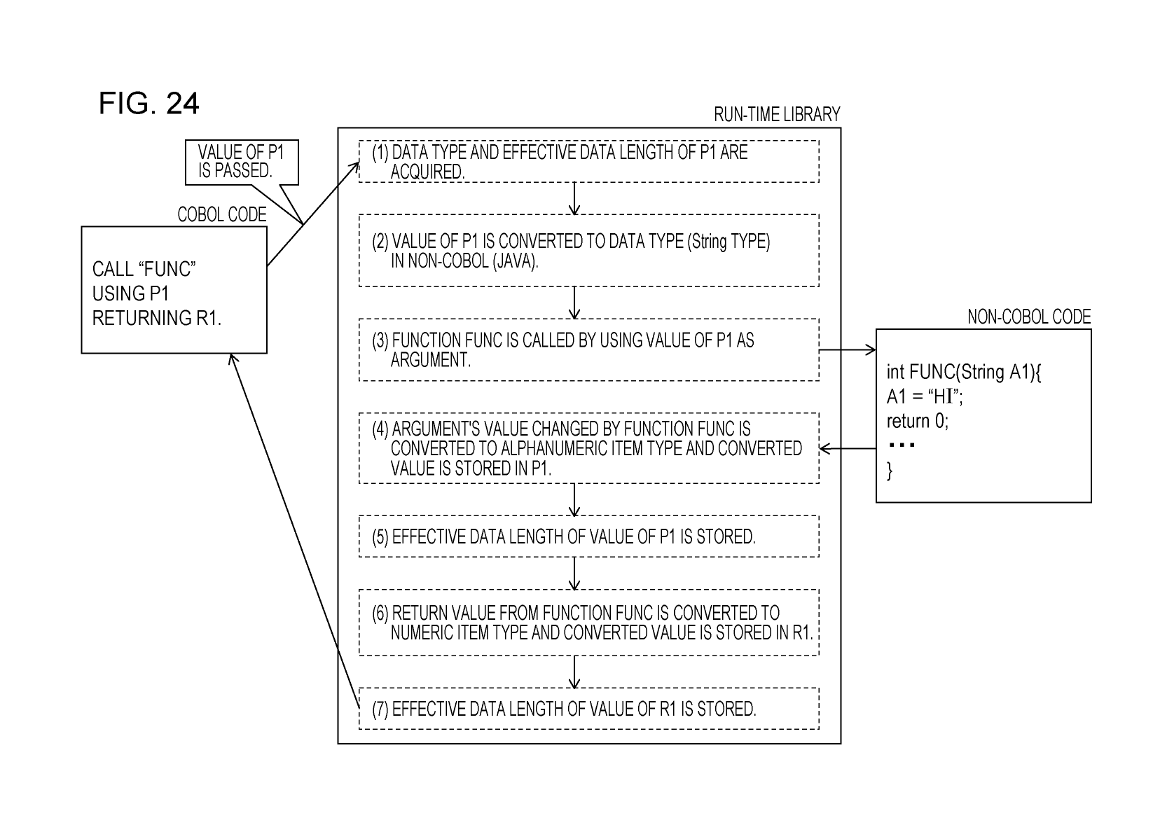

FIG. 22 illustrates a case in which processing has been executed in response to ‘MOVE “ABCD” TO P1.’ in the source code in FIG. 19. FIG. 23 illustrates a case in which processing has been executed in response to ‘MOVE “EFG” TO P1.’ in the source code in FIG. 19. FIGS. 24 to 27 illustrate cases in which processing has been executed in response to ‘CALL “FUNC” USING P1 RETURNING R1.’ in the source code in FIG. 19.

When processing is executed in response to ‘MOVE “ABCD” TO P1.’ in the source code in FIG. 19, the object executing section 112 stores information indicating ABCD in an area at addresses 2100 to 2103 in the memory 102 in the information processing apparatus 1 as illustrated in FIG. 22 (S31).

The object executing section 112 also stores information (1 in the example in the example in FIG. 22), which indicates the alphanumeric item type, which is the data type of ABCD, in the area at address 2000 in the memory 102 in the information processing apparatus 1 as illustrated in FIG. 22 (S32). The object executing section 112 further stores 4, which indicates the effective data length of ABCD, in the area at address 2001 in the memory 102 in the information processing apparatus 1 as illustrated in FIG. 22 (S32). The object executing section 112 may determine information to be stored in the area at address 2000 in the memory 102 with reference to, for example, information that includes the name of a data type and information indicating the data type in correspondence to each other (information that includes information indicating that the alphanumeric item type corresponds to 1 and information indicating that the numeric item type corresponds to 2).

Thus, the object executing section 112 can retain information about the data type of the value of the data item P1 and its effective data length in correspondence to the value of the data item P1.

Next, a state in which processing has been executed in response to ‘MOVE “EFG” TO P1.’ in the source code in FIG. 19 will be described with reference to FIG. 23. When processing is executed in response to ‘MOVE “EFG” TO P1.’ in the source code in FIG. 19, the object executing section 112 stores information indicating EFG in an area at addresses 2100 to 2102 in the memory 102 in the information processing apparatus 1 as illustrated in FIG. 23 (S31). In this case, the effective data length of the value of the data item P1 is 3, so the effective data length is shorter than the area length of the value of the data item P1, which is 4. Therefore, the object executing section 112 stores space-indicating information in an area at address 2103 as illustrated in FIG. 23.

The object executing section 112 then stores 1 indicating alphanumeric item type, which is the data type of ABCD, in an area at address 2000 in the memory 102 in the information processing apparatus 1, as illustrated in FIG. 23 (S32). The object executing section 112 further stores 3 indicating the effective data length of EFG in an area at address 2001 in the memory 102 in the information processing apparatus 1, as illustrated in FIG. 23 (S32).

Therefore, even if the value of the data item P1 is updated, the object executing section 112 can retain information about the data type of the updated value of the data item P1 and the effective data length of the updated value.

Referring again to FIG. 16, the object executing section 112 decides whether after processing in S31 and S32 in FIG. 17 had been executed, all commands included in the first object have been executed (S25). If all commands included in the first object have been executed (the result in S25 is Yes), the object executing section 112 terminates the object execution processing. If all commands included in the first object have not been executed (the result in S25 is No), the object executing section 112 repeatedly executes processing in S21 and later steps.

If the command acquired in S21 is not a command that stores a new value in the first variable (the result in S22 is No), the object executing section 112 decides whether the command acquired in S21 is a command that executes the second object by using the value of the first variable as an argument (S23).

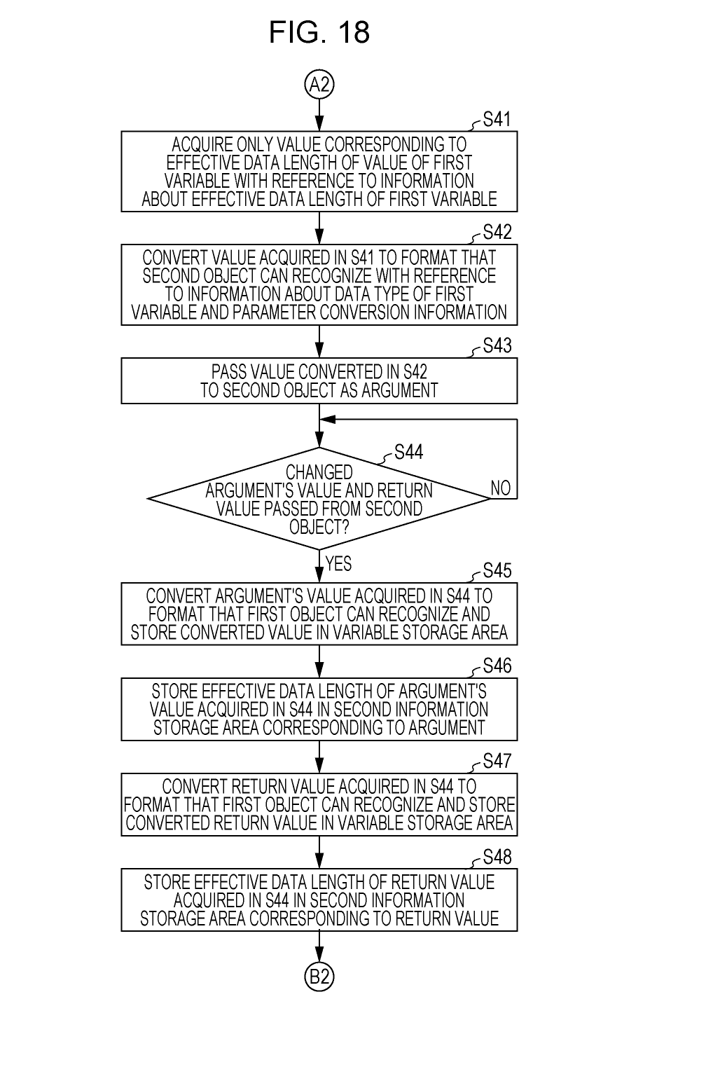

If the command acquired in S21 is a command that executes the second object by using the value of the first variable as an argument (the result in S23 is Yes), the parameter converting section 113 references information about the effective data length of the first variable as illustrated in FIG. 18 (S41). The parameter converting section 113 then acquires only the value corresponding to the effective data length of the value of the first variable (S41)

That is, as illustrated in FIG. 24, when the value of the first variable is passed from the first object as an argument, the parameter converting section 113 can acquire the effective data length of the value of the first variable with reference to the memory 102 in the information processing apparatus 1 ((1) in FIG. 24). Therefore, the parameter converting section 113 can quickly perform processing to identify the value corresponding to the effective data length of the first variable's value passed from the first object.

The parameter converting section 113 also converts the value acquired in S41 to a format that the second object can recognize with reference to information about the data type of the first variable (S42).

That is, as illustrated in FIG. 24, when the value of the first variable is passed from the first object as an argument, the parameter converting section 113 can acquire the data type of the value of the first variable with reference to the memory 102 in the information processing apparatus 1 ((1) in FIG. 24). Therefore, the developer may not prepare a plurality of parameter converting sections 113 so as to correspond to all values that are likely to be passed from the first object, as described with reference to FIG. 5. The state of the memory 102 in the information processing apparatus 1 when processing in S42 has been executed will be described below.

State of the Memory 102 when Processing in S42 has Been Executed

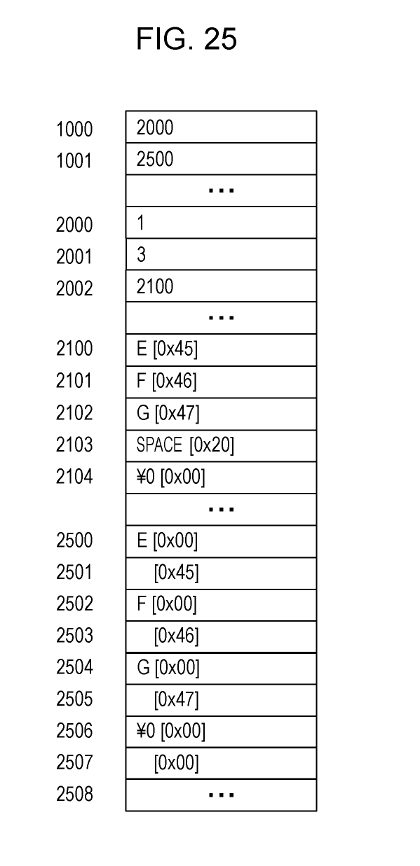

FIG. 25 illustrates a case in which processing has been executed in response to ‘CALL “FUNC” USING P1 RETURNING R1.’ in the source code in FIG. 19. As illustrated in FIGS. 24 and 25, when the parameter converting section 113 has converted the value of the data item P1 to a format that the second object can recognize, the parameter converting section 113 stores a converted value in the memory 102 in the information processing apparatus 1 ((2) in FIG. 24).

Specifically, the parameter converting section 113 converts the character codes of EFG, which is the value of the data item P1, from ASCII to Unicode as illustrated in FIG. 25. The parameter converting section 113 then stores values converted to Unicode in an area starting from address 2500 in the memory 102 in the information processing apparatus 1, as illustrated in FIG. 25. Therefore, the parameter converting section 113 can convert the value of the data item P1 to a format that the second object can recognize.

Referring again to FIG. 18, the parameter converting section 113 passes the value converted in S42 to the second object as an argument to call a function included in the second object (S43, (3) in FIG. 24). In the example in FIG. 25, the second object may acquire an argument (EFG) used to execute a function called from the first object with reference to the area starting from address 2500 in the memory 102 in the information processing apparatus 1.

After that, the parameter converting section 113 waits until an execution result (changed argument's value and a return value) of the function called from the first object is passed from the second object to the parameter converting section 113 (the result in S44 is No). When a changed argument's value and a return value are passed from the second object, (the result in S44 is Yes), the parameter converting section 113 converts the argument's value acquired in S44 to a format that the first object can recognize and stores the converted value in the variable storage area 102a (S45, (4) in FIG. 24).

In this case, the parameter converting section 113 also stores the effective data length of the argument's value acquired in S44 in the second information storage area 102c corresponding to the variable storage area 102a in which the argument's value changed in conversion executed in S45 is stored (S46, (5) in FIG. 24). Thus, even if the value of an argument has been changed due to a request from the first object to execute a function included in the second object, the parameter converting section 113 can store the effective data length of the changed argument's value in the second information storage area 102c.

The parameter converting section 113 further converts the return value acquired in S44 to a format that the first object can recognize and stores the converted return value in the variable storage area 102a (S47, (6) in FIG. 24). In this case, the parameter converting section 113 also stores the effective data length of the return value acquired in S44 in the second information storage area 102c corresponding to the variable storage area 102a in which the return value changed in conversion executed in S47 is stored (S48, (7) in FIG. 24). Thus, when the first object requests the execution of a function included in the second object, the parameter converting section 113 can store, in the second information storage area 102c, the effective data length corresponding to the return value from the function included in the second object. The state of the memory 102 in the information processing apparatus 1 when processing in S45 and S46 has been executed will be described.

State of the Memory 102 when Processing in S45 and S46 has Been Executed

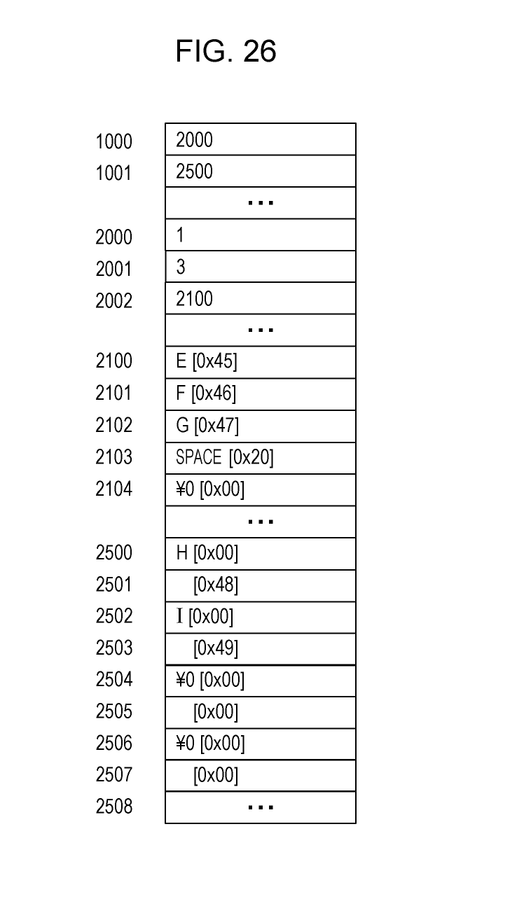

FIG. 26 illustrates the state of the memory 102 in the information processing apparatus 1 when processing had been executed in response to ‘CALL “FUNC” USING P1 RETURNING R1.’ in the source code in FIG. 19, after which a changed argument's value and return value have been passed from a function included in the second object. The following description will cover only the changed argument's value passed from the second object and will not cover the return value passed from the second object.

Specifically, as illustrated in, for example, FIG. 26, the second object stores HI, which is an argument that has been changed by a function called from the first object, in an area starting from address 2500 in the memory 102 in the information processing apparatus 1. In this case, information indicating HI is stored in an area at addresses 2500 to 2503 and information indicating NULL (\0) is stored in an area at addresses 2504 and 2505. In the example in FIG. 26, therefore, new information is not stored in an area at addresses 2506 and 2507, so NULL (\0), which is information stored in FIG. 25, is left in an area at addresses 2506 and 2507 in FIG. 26 without alteration.

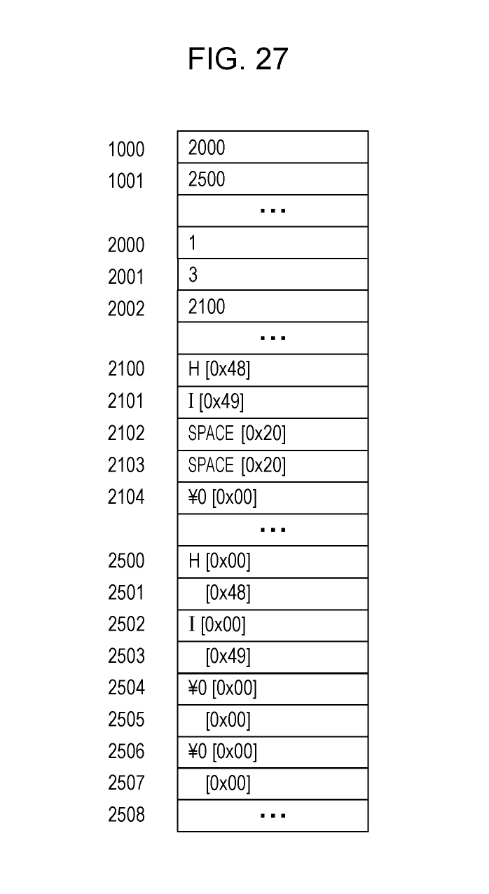

Next, a case will be described in which processing had been executed in response to ‘CALL “FUNC” USING P1 RETURNING R1.’ in the source code in FIG. 19, after which the parameter converting section 113 has changed an argument passed from the second object to a format that the first object can recognize. FIG. 27 illustrates a case in which processing had been executed in response to ‘CALL “FUNC” USING P1 RETURNING R1.’ in the source code in FIG. 19, after which the parameter converting section 113 has changed an argument passed from the second object to a format that the first object can recognize.

Specifically, the parameter converting section 113 converts the character codes of HI stored in the area starting from address 2500 from Unicode to ASCII as illustrated in FIG. 27. The parameter converting section 113 then stores the values converted to ASCII in an area starting from address 2100 in the memory 102 in the information processing apparatus 1 as illustrated in FIG. 27. Thus, the parameter converting section 113 can convert the argument and return value passed from the second object to a format that the first object can recognize.

The effective data length of the values (indicating HI) stored in the area (area starting from 2100) of the data item P1 is 2. Therefore, the parameter converting section 113 acquires, from the first object code, information indicating that, for example, the area data length of the data item P1 is 4, and adds space-indicating information to an area that follows the values stored in the area starting from address 2100. Specifically, the parameter converting section 113 adds space-indicating information to an area at address 2102 and an area at address 2103, as illustrated in FIG. 27.

The parameter converting section 113 further stores, in an area at address 2001, information indicating that the effective data length of the values (indicating HI) stored in the data item P1 is 2, as illustrated in FIG. 27. Thus, even if the value of an argument has been changed due to a request from the first object to execute a function included in the second object, the parameter converting section 113 can retain the effective data length corresponding to the changed argument's value and return value.

Referring again to FIG. 16, if the object executing section 112 decides in processing in S23 that the command acquired in S21 is not a command that executes the second object by using the value of the first variable as an argument (the result in S23 is No), the object executing section 112 executes the command acquired in S21 (S24).

As described above, the information processing apparatus 1 allocates the first information storage area 102b, in which to store information about the data type of the first variable, in correspondence to the variable storage area 102a in which to store the first variable included in the first source code. The information about the data type of the first variable, the information being stored in the first information storage area 102b, is updated when the first variable is updated during the execution of the first object generated from the first source code and is acquired by an external program together with the first variable in the variable storage area 102a.

Thus, when converting the first variable's value passed from the first object to a format that the second object can recognize, the developer may not prepare a plurality of run-time libraries, each of which corresponds to one data type of the value of the first variable. When a function included in the second object is changed, the developer may not change the parameter converting section 113 or first source code.

In the examples above, a case has been described in which when compiling the first source code, the compilation executing section 111 allocates an information storage area in which to store information about the actual data type of the first variable and information about the effective data length of the first variable together with the variable storage area 102a in which to store the value of the first variable. In addition to this, the compilation executing section 111 may allocate, for example, an information storage area in which to store the area data length of the first variable. Accordingly, when the parameter converting section 113 converts an argument's value and return value passed from the second object to a format that the first object can recognize (S45 and S47 in FIG. 18), the parameter converting section 113 can quickly acquire information about the area data length.

The compilation executing section 111 may allocate, for example, an information storage area in which to store the first variable's data type declared when the first variable was declared.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a complier process comprising:
allocating a first information storage area, in which to store a data type of a first variable included in first source code, in correspondence to a storage area, in which to store the first variable, and
updating the data type stored in the first information storage area when the first variable is updated during execution of a first object made from the first source code, and making the data type capable of being acquired by an external program together with the first variable stored in the storage area.

2. The non-transitory, computer-readable storage medium according to claim 1, wherein the first information storage area stores information configured to identify an address of the storage area.

3. The non-transitory, computer-readable storage medium according to claim 1, wherein:
the first source code is written in common business-oriented language (COBOL);
in allocation of the first information storage area, when the data type of the first variable is a fixed-length character type, a second information storage area, in which to store an effective data length of the first variable, is allocated in correspondence to the storage area; and
the effective data length stored in the second information storage area is updated when the first variable is updated during execution of the first object and is acquired by the external program together with the first variable stored in the storage area.

4. The non-transitory, computer-readable storage medium according to claim 3, wherein:
when a second object made from second source code written in a language different from a language in which the first source code is written is executed by using the first variable as an argument, the first object uses a run-time library using the first variable; and
the run-time library converts, with reference to the data type of the first variable passed from the first object, the first variable to a data format that the second object is capable of recognizing, and passes the first variable that has been converted to the second object.

5. The non-transitory, computer-readable storage medium according to claim 4, wherein the run-time library converts, with reference to the effective data length of the first variable, only data corresponding to the effective data length of the first variable to a data format that the second object is capable of recognizing.

6. The non-transitory, computer-readable storage medium according to claim 1, wherein a second variable different from the first variable, or a constant is transcribed to the first variable to update the first variable.

7. A compilation apparatus, comprising:
a memory; and
a processor coupled to the memory and configured to:
allocate a first information storage area, in which to store a data type of a variable included in source code written in common business-oriented language (COBOL), in correspondence to a storage area, in which to store the variable, and
update the data type stored in the first information storage area when the variable is updated during execution of an object made from the source code, and make the data type capable of being acquired by an external program together with the variable stored in the storage area.

8. The non-transitory, compilation apparatus according to claim 7, wherein:
in processing in which the first information storage area is allocated, when the data type of the variable is a fixed-length character type, a second information storage area, in which to store an effective data length of the variable, is allocated in correspondence to the storage area; and
the effective data length stored in the second information storage area is updated when the variable is updated during execution of the object and is acquired by the external program together with the variable stored in the storage area.

9. A compilation method, comprising:
allocating, using a computer, a first information storage area, in which to store a data type of a variable included in source code, in correspondence to a storage area, in which to store the variable, and
updating, using the computer, the data type stored in the first information storage area when the variable is updated during execution of an object made from the source code, and making, using the computer, the data type capable of being acquired by an external program together with the variable stored in the storage area.

10. The compilation method according to claim 9, wherein:
in allocation of the first information storage area, when the data type of the variable is a fixed-length character type, a second information storage area, in which to store an effective data length of the variable, is allocated in correspondence to the storage area; and
the effective data length stored in the second information storage area is updated when the variable is updated during execution of the object and is acquired by the external program together with the variable stored in the storage area.
